(19) United States
(12) Patent Application Publication
(10) Pub. No.: US 2010/0268595 A1
(43) Pub. Date: Oct. 21, 2010

(54) ADVERTISING CAPABILITY FOR IN-HOME DISPLAY AND SMART APPLIANCES

(76) Inventor: Nathan Bowman Littrell, Gardnerville, NV (US)

Correspondence Address: JOHN S. BEULICK (17851);ARMSTRONG TEASDALE LLP, 7700 Forsyth Boulevard, Suite 1800, St. Louis, MO, 63105, US

(21) Appl. No.: 12/425,667

(22) Filed: Apr. 17, 2009

(51) Int. Cl. G06Q 30/00

(52) U.S. Cl. 705/14.49

(57) ABSTRACT

A system for broadcasting at least one advertisement is provided. The system includes a database configured to store the at least one advertisement, a server communicatively coupled to the database, wherein the server is configured to schedule the playlist that includes at least one of the at least one advertisement, and an appliance communicatively coupled to the server, wherein the appliance includes a screen, a portion of the screen configured to broadcast the playlist.

### BACKGROUND OF THE INVENTION

The field of the present invention relates generally to advertising and, more particularly, to methods and systems for broadcasting advertisements over a smart grid system.

At least some known smart grid systems deliver a utility, such as electric power/electricity, from a utility provider to a plurality of consumers using digital technology to improve efficiency, reliability, and safety as compared to consumers using more traditional grids. More specifically, the efficiencies and improvements afforded by smart grids are such that it has been estimated that updating existing grid systems in the United States with smart grid capabilities would save between $46 and 117 billion over the next twenty years.

Known smart grid systems include a communication infrastructure that use a plurality of in-home displays to provide utility-related information, but at least a portion of some known smart grid communication infrastructures remain unused.

### BRIEF SUMMARY OF THE INVENTION

In one embodiment, a method for broadcasting at least one advertisement on an appliance is provided. The method includes scheduling a playlist that includes at least one of the at least one advertisement and broadcasting at least a portion of the playlist on the appliance.

In another embodiment, a server for use with a system for broadcasting at least one advertisement on an appliance that includes a screen is provided. The server is configured to receive the at least one advertisement, schedule a playlist that includes at least one of the at least one advertisement, and transmit the playlist to the appliance enabling the appliance to broadcast at least a portion of the playlist on at least a portion of the screen.

In yet another embodiment, a system for broadcasting at least one advertisement is provided. The system includes a database configured to store the at least one advertisement, a server communicatively coupled to the database, wherein the server is configured to schedule the playlist that includes at least one of the at least one advertisement, and an appliance communicatively coupled to the server, wherein the appliance includes a screen, a portion of the screen configured to broadcast the playlist.

### BRIEF DESCRIPTION OF THE DRAWINGS

FIG. 1 is a schematic illustration of an exemplary smart grid system;

FIG. 2 is a detailed schematic illustration of the exemplary smart grid system shown in FIG. 1;

FIG. 3 is a flow chart illustrating an exemplary method for the exemplary smart grid system shown in FIG. 1; and

FIG. 4 is a detailed flow chart illustrating an exemplary method for the exemplary smart grid system shown in FIG. 1.

### DETAILED DESCRIPTION OF THE INVENTION

The systems and methods described herein broadcast advertising and/or other information over a smart grid system. Broadcast is defined as visually and/or audibly presenting or displaying at least one of a static image, a dynamic image, a monochromatic image, a color image, and/or a sound. Smart grid is referred to by other names including Smart Electric Grid, Smart Power Grid, Intelligent Grid/Intelligrid, and FutureGrid. The systems and methods described herein also facilitate the generation of a revenue stream by providing a medium of advertising to potential advertisers.

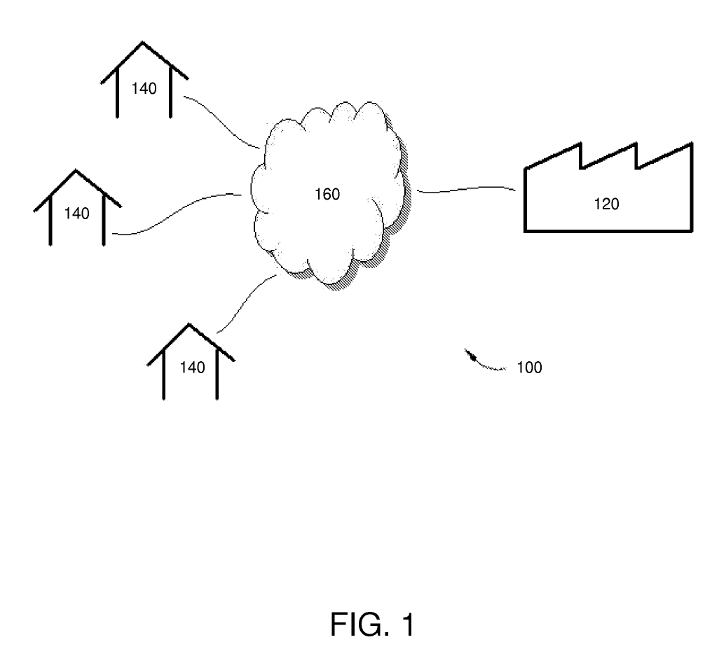

FIG. 1 is a schematic illustration of an exemplary smart grid system 100. In the exemplary embodiment, system 100 couples at least one utility provider 120 to a plurality of consumers 140 via a network 160. In one embodiment, provider 120 is an electric company that provides electric power/electricity to consumers 140. Notably, system 100 is not limited to any particular utility and may include a water utility, an electricity utility, and a natural gas utility.

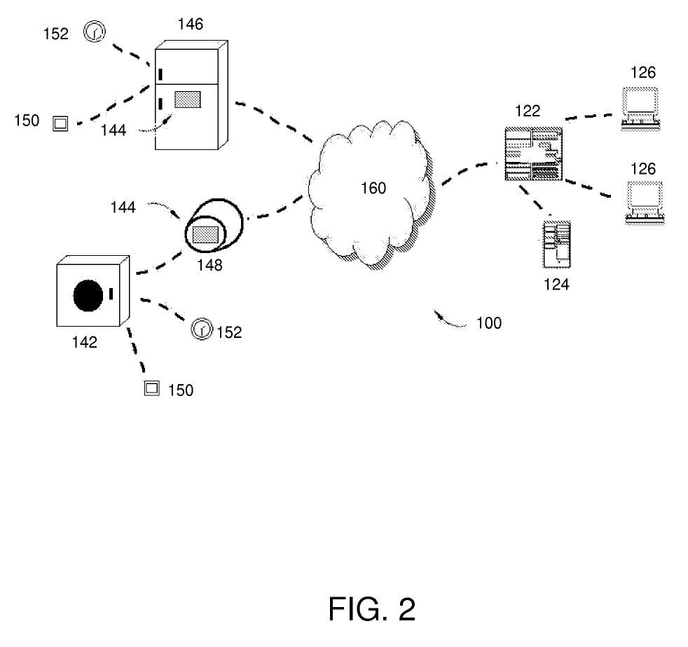

FIG. 2 is a detailed schematic illustration of smart grid system 100. In the exemplary embodiment, system 100 includes a server 122, a database 124, a plurality of client systems 126, a smart appliance 142, and a legacy appliance 146. Additionally, system 100 may include at least one meter (not shown) that facilitates managing the use of utilities. The term “appliance” is defined as a device with a narrow function. The term “appliance” includes, but is not limited to, machines that accomplish routine housekeeping tasks such as cooking, food preservation, and/or cleaning. Moreover, the term “appliance” includes, but is not limited to, fixtures that require a higher current of electricity than standard electrical outlets can deliver. Further, the term “appliance” includes, but is not limited to, machines that enable efficiently operating other machines that accomplish routine housekeeping tasks. Notably, the term “appliances” does not include traditional sources of entertainment, such as radios, televisions, desktop computers, and/or laptop computers.

In the exemplary embodiment, server 122 includes a processor and is communicatively coupled to database 124, to client system 126, and to network 160. In the exemplary embodiment, smart appliance 142 is a home appliance that includes a processor that is communicatively coupled to network 160. Smart appliance 142 is also known as an information appliance, a web appliance, or an Internet appliance. In the exemplary embodiment, legacy appliance 146 is a conventional home appliance that does not include a processor, but rather legacy appliance 146 is communicatively coupled to network 160 via an interface unit 148. Interface unit 148 includes a processor that facilitates communicatively coupling legacy appliance 146 to network 160.

In the exemplary embodiment, smart appliance 142 is a refrigerator, and legacy appliance 146 is a dryer. Notably, smart appliance 142 and legacy appliance 146 are not limited to any particular appliance and may include, but is not limited to, microwave ovens, ovens, ranges, dishwashers, freezers, refrigerators, clothes dryers, washing machines, water heaters, air conditioning units, heating and ventilation units, dehumidifiers, pumps, and/or aquariums.

In the exemplary embodiment, server 122, client system 126, smart appliance 142, and interface unit 148 each include at least one processor and at least one database that receive, store, and transmit data related to either consumer information and/or advertiser information. In the exemplary embodiment, smart appliance 142 and interface unit 148 each include a screen 144 that broadcasts advertisements and/or other information. Notably, in the exemplary embodiment, smart appliance 142 and interface unit 148 perform substantially similar functions and may be used interchangeably within the detailed description of the invention. Additionally, system 100 may include a single in-home display (not shown) that aggregates data from at least one other appliance and at least one on-site meter.

In the exemplary embodiment, smart appliance 142 and interface unit 148 are wirelessly coupled to network 160. Alternatively, either smart appliance 142 and/or interface unit 148 is coupled to network 160 via a wired connection such as a telephone jack and an Ethernet jack. In the exemplary embodiment, network 160 is a communication infrastructure that includes at least one of a public network, a private network, a local area network (LAN), wide area network (WAN), the Internet, and a powerline communication (e.g., Homeplug).

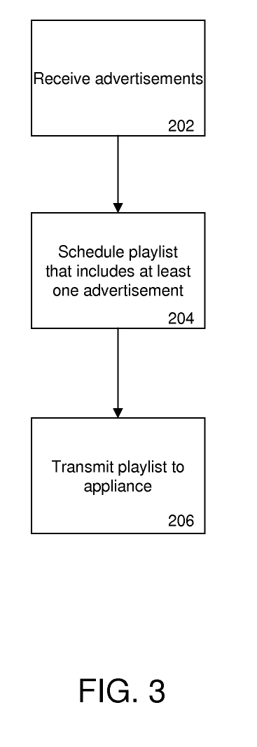

FIG. 3 is a flow chart of an exemplary method of advertising that may be used with smart grid system 100. In the exemplary embodiment, client system 126 receives a plurality of advertisements from an advertiser, and then client system 126 transmits the plurality of advertisements to server 122. In the exemplary embodiment, server 122 receives 202 the plurality of advertisements from client system 126 and stores the plurality of advertisements on database 124. Database 124 is communicatively coupled to server 122, and, in the exemplary embodiment, server 122 schedules 204 a playlist that includes at least one of the plurality of advertisements. Server 122 transmits 206 the playlist to smart appliance 142 via network 160. In the exemplary embodiment, smart appliance 142 broadcasts at least a portion of the playlist on at least a portion of screen 144. For example, screen 144 may be configured to broadcast the playlist on at least one of a corner of screen 144, a scroll bar across screen 144, or on an entire screen 144. In another example, screen 144 may be configured to audibly broadcast the playlist. Additionally, server 122 may transmit 206 the playlist to a stand-alone device (not shown) via network 160. In such an embodiment, screen 144 is coupled to the stand alone device, which aggregates data from at least one other appliance and at least one on-site meter.

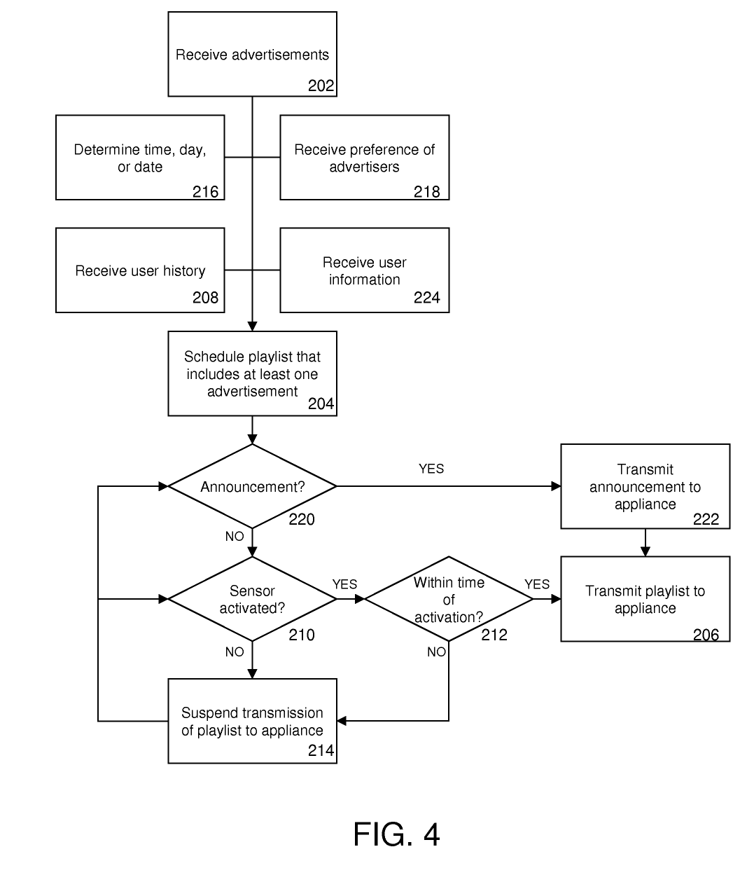

FIG. 4 is a detailed flow chart of an exemplary method of advertising that may be used with smart grid system 100. In the exemplary embodiment, server 122 schedules 204 a playlist based on any number of factors such as, but not limited to, a user history, a time, day, or date, a preference of advertisers, a user information, and/or a combination of any of the aforementioned factors. Additionally, server 122 may schedule 204 a playlist based at least in part on data provided by at least one electric meter (not shown).

In the exemplary embodiment, smart appliance 142 monitors a user history, including an appliance usage, an appliance energy consumption, and/or a utility pricing. In the exemplary embodiment, appliance usage may include information related to a history of when, how, and an elapsed timed period that an appliance has been used. For example, appliance usage may indicate that a washer was used on Friday, February 29 at 8:09 pm for thirty three minutes using a delicates cycle. In the exemplary embodiment, appliance energy consumption includes, but is not limited to, information related to a history indicating time periods when an appliance consumes energy and how much energy the appliance consumes. For example, an energy consumption history may indicate that a refrigerator consumed 40.3 W from 3:00-3:59 pm and 100.8 W from 4:00-4:59 pm. In the exemplary embodiment, utility pricing includes but is not limited to information related to a history of total price and price per unit. For example, utility pricing may indicate that it cost $0.11 to operate an air conditioning unit from 5:00-5:59 pm at $0.15 per kWhr. In the exemplary embodiment, smart appliance 142 transmits the user history to server 122 to enable server 122 to schedule 204 a playlist based at least in part on the user history. Moreover, in the exemplary embodiment, the user histories are stored on database 124.

In the exemplary embodiment, smart appliance 142 determines 216 at least one of a time of day, a day of week, and a date of month. For example, server 122 may schedule the playlist from 5:30-6:30 pm based on a determination that, based on the user history, smart appliance 142 is used every Friday night around 6:00 pm. In another example, database 124 may include information, such as a billing due date for consumer 140, and server 122 may schedule the playlist for the days preceding the billing due date. In the exemplary embodiment, server 122 schedules 204 the playlist based at least in part on at least one of the time, the day, and the date and store the at least one of the time, the day and the date on database 124.

In the exemplary embodiment, client system 126 receives 218 a predetermined preference, rank, or weight of a plurality of advertisers. For example, client system 126 may receive information regarding a first advertiser's purchase of time for a first amount of money and a second advertiser's purchase of time for a second amount of money that is less that the first amount of money. In such an example, client system 126 may weight or rank the first advertiser ahead of the second advertiser because the first advertiser provided more money. In the exemplary embodiment, client system 126 transmits the preference of advertisers to server 122 to enable server 122 to schedule 204 the playlist based at least in part on the preference of advertisers and stores the preference of advertisers on database 124. Additionally, server 122 may track the scheduling of the playlist and/or the transmission of the playlist and use the data from the tracking to bill an advertiser on a pay-per-schedule and/or pay-per-play basis.

In the exemplary embodiment, client system 126 receives 224 user information that includes at least one of a name, an occupation, an income, and an address for consumer 140. For example, client system 126 may receive user information identifying that Dr. John Doe of 123 King Street in Alexandria, Va. is a surgeon who earns over $300,000 per year. In the exemplary embodiment, client system 126 transmits the user information to server 122, and server 122 schedules 204 the playlist based at least in part on the user information and stores the user information on database 124.

In the exemplary embodiment, either server 122 and/or smart appliance 142 determines 220 when an announcement should be broadcast. In the exemplary embodiment, the announcement may include, but is not limited to a predetermined reminder, a public service announcement, and an emergency alert. In the exemplary embodiment, after an affirmative identification of the announcement, server 122 transmits 222 the announcement to smart appliance 142. In the exemplary embodiment, server 122 interrupts the playlist to transmit 222 the announcement. For example, smart appliance 142 may receive from consumer 140 a reminder that a football game starts at 3:00 pm. In such an example, server 122 may interrupt the playlist to broadcast the reminder at a predetermined time before the start of the event. For another example, client system 126 may receive an emergency alert that a hurricane is expected to reach land in two days. In such an example, server 122 may interrupt the playlist to broadcast the emergency alert at a predetermined time and/or at predetermined time intervals. In the exemplary embodiment, either client system 126 and/or smart appliance 142 transmits the announcement to server 122, and server 122 transmits 206 the playlist around the announcement and stores the announcement on database 124. In the exemplary embodiment, after completing the transmission of the announcement, server 122 transmits 206 the playlist to smart appliance 142. In an alternate embodiment, smart appliance 142 stores the announcement, interrupts the playlist, broadcasts the announcement, and automatically resumes the broadcasting of the playlist after completing the broadcast of the announcement.

In the exemplary embodiment, smart appliance 142 determines 210 when a sensor 150 has been activated. For example, in the exemplary embodiment, activation of sensor 150 indicates that consumer 140 is in the vicinity of smart appliance 142. In the exemplary embodiment, after identifying the activation, server 122 transmits 206 the playlist to smart appliance 142. More specifically, sensor 150 and a timer 152 work in cooperation to ensure a signal is transmitted to server 122 for a predetermined amount of time based on an amount of time elapsed after sensor 150 was most recently activated. Additionally, consumer 140 may interrupt the transmission and/or broadcast of the playlist. In such an embodiment, consumer 140 would have the option to cancel and/or suspend an advertisement. Server 122 transmits 206 the playlist to smart appliance 142 within the predetermined amount of time. In the exemplary embodiment, server 122 suspends 214 the transmission of the playlist when either sensor 150 has not been activated and/or elapsed time is outside of the predetermined amount of time. In the exemplary embodiment, 214, the suspension of the transmission facilitates reducing an amount of energy required to transmit and broadcast the playlist on smart appliance 142. Alternatively, smart appliance 142 broadcasts the playlist for a predetermined amount of time based on timer 152 after sensor 150 has been most recently activated.

In one embodiment, a server, a client system, a computer, and a smart appliance, such as described herein, includes at least some form of computer readable media. By way of example and not by limitation, such computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

Embodiments of the invention are operational with numerous other general purpose or special purpose computing system environments or configurations. Examples that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more controllers, computers, or other devices. Aspects of the invention may be implemented with any number and organization of components or modules. For example, aspects of the invention are not limited to the specific computer-executable instructions or the specific components or modules illustrated in the figures and described herein. Alternative embodiments of the invention may include different computer-executable instructions or components having more or less functionality than illustrated and described herein.

The order of execution or performance of the operations in the embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

Technical effects of the methods, systems, and computers described herein include at least one of (a) receiving at least one advertisement; (b) receiving a history related to at least one of an appliance usage, an appliance energy consumption, and a utility pricing; (c) determining at least one of a time of day, a day of week, and a date of month; (d) receiving a predetermined preference of a plurality of advertisers; (e) receiving user information that includes at least one of a name, an occupation, an income, and an address for a user of the appliance; (f) scheduling a playlist that includes the at least one advertisement; (g) transmitting the playlist to an appliance that includes a screen based on at least one a timer and a sensor coupled to the appliance, a portion of the screen configured to broadcast the playlist; (h) interrupting the playlist for an announcement that includes at least one of a predetermined reminder, a public service announcement, and an emergency alert; and (i) automatically resuming the broadcast of the playlist after completing the broadcast of the announcement.

The methods and systems for an advertising capability for in-home display and smart appliances described herein enable advertising over a smart grid system. Exemplary embodiments of an advertising capability for in-home display and smart appliances and a method for broadcasting advertisements on an in-home display are described above in detail. The methods and systems are not limited to the specific embodiments described herein, but rather, components of the methods and systems may be utilized independently and separately from other components described herein. For example, the methods and systems described herein may have other industrial and/or consumer applications and are not limited to practice with a smart grid system as described herein. Rather, the present invention can be implemented and utilized in connection with many other industries.

While the invention has been described in terms of various specific embodiments, those skilled in the art will recognize that the invention can be practiced with modification within the spirit and scope of the claims.

What is claimed is:

1. A method for broadcasting at least one advertisement on an appliance, said method comprising:
scheduling a playlist that includes the at least one advertisement; and
broadcasting at least a portion of the playlist on the appliance.

2. A method in accordance with claim 1, wherein said method further comprises:
receiving a history related to at least one of an appliance usage, an appliance energy consumption, and a utility pricing; and
scheduling the playlist based on the history.

3. A method in accordance with claim 1, wherein broadcasting at least a portion of the playlist comprises broadcasting the playlist based on at least a timer and a sensor coupled to the appliance.

4. A method in accordance with claim 1, wherein scheduling a playlist comprises scheduling the playlist based on at least one of a time of day, a day of week, or a date of month.

5. A method in accordance with claim 1, wherein said method further comprises:
receiving a predetermined preference of a plurality of advertisers, each of the plurality of advertisers providing at least one advertisement; and
scheduling the playlist based on the predetermined preference of the plurality of advertisers.

6. A method in accordance with claim 1, wherein broadcasting at least a portion of the playlist comprises broadcasting the playlist such that the playlist may be interrupted for at least one of a predetermined reminder, a public service announcement, an emergency alert, and a user command.

7. A method in accordance with claim 1, wherein said method is further comprises:
receiving user information that includes at least one of a name, an occupation, an income, and an address for a user of the appliance;
scheduling the playlist based on the user information.

8. A server for use with a system for broadcasting at least one advertisement on an appliance that includes a screen, said server configured to:
receive the at least one advertisement;
schedule a playlist that includes at least one of the at least one advertisement; and
transmit the playlist to the appliance enabling the appliance to broadcast at least a portion of the playlist on at least a portion of the screen.

9. A server in accordance with claim 8, wherein said server is further configured to:
receive a history related to at least one of an appliance usage, an appliance energy consumption, and a utility pricing; and
schedule the playlist based on the history.

10. A server in accordance with claim 8, wherein said server is further configured to transmit the playlist based on at least one a timer and a sensor coupled to the appliance.

11. A server in accordance with claim 8, wherein said server is further configured to schedule the playlist based on at least one of a time of day, a day of week, or a date of month.

12. A server in accordance with claim 8, wherein said server is further configured to:
receive a predetermined preference of a plurality of advertisers, each of the plurality of advertisers providing at least one advertisement; and
schedule the playlist based on the predetermined preference of the plurality of advertisers.

13. A server in accordance with claim 8, wherein said server is further configured to interrupt the playlist for at least one of a predetermined reminder, a public service announcement, an emergency alert, and a user command.

14. A server in accordance with claim 8, wherein said server is further configured to:
receive user information that includes at least one of a name, an occupation, an income, and an address for a user of said appliance;
schedule the playlist based on the user information.

15. A system for broadcasting at least one advertisement, said system comprising:
a database configured to store the at least one advertisement;
a server communicatively coupled to said database, said server configured to schedule the playlist that includes at least one of the at least one advertisement; and
an appliance communicatively coupled to said server, said appliance comprising a screen, a portion of said screen configured to broadcast the playlist.

16. A system in accordance with claim 15, wherein said server is configured to receive a history related to at least one of an appliance usage, an appliance energy consumption, and a utility pricing, said server configured to schedule the playlist based on said history.

17. A system in accordance with claim 15, wherein said server is further configured to transmit the playlist based on at least one of a timer and a sensor coupled to said appliance.

18. A system in accordance with claim 15, wherein said server is further configured to schedule the playlist based on at least one of a time of day, a day of week, or a date of month.

19. A system in accordance with claim 15, wherein said server is further configured to:
receive a predetermined preference of a plurality of advertisers, each of the plurality of advertisers providing at least one advertisement; and
schedule said playlist based on the predetermined preference of the plurality of advertisers.

20. A system in accordance with claim 15, wherein said server is further configured to interrupt the playlist for at least one of a predetermined reminder, a public service announcement, an emergency alert, and a user command.
